(19) United States
(12) Patent Application Publication
(10) Pub. No.: US 2020/0076717 A1
(43) Pub. Date: Mar. 5, 2020

(54) MONITORING PACKET LOSS IN COMMUNICATIONS USING STOCHASTIC STREAMING

(71) Applicant: Cisco Technology, Inc., San Jose, CA (US)

(72) Inventors: Ralf Rantzau, San Jose, CA (US); Rajath Agasthya, San Jose, CA (US); Sebastian Jeuk, Munich (DE); Gonzalo Salgueiro, Raleigh, NC (US)

(21) Appl. No.: 16/117,235

(22) Filed: Aug. 30, 2018

(51) Int. Cl. H04L 12/26; H04L 12/927

(52) U.S. Cl. CPC H04L 43/0829; H04L 47/80

(57) ABSTRACT

Techniques for monitoring packet loss in communications using stochastic streaming algorithms are provided. In an embodiment, a server computer receives data identifying a plurality of data packet drop events from an electronic digital network element. The server computer creates and stores in computer memory a plurality of frequency tables which track packet loss for a plurality of items, each frequency table corresponding to an attribute of a monitored attribute type and a snapshot time. The server computer identifies, for each frequency table, one or more items of the plurality of items that are associated with a frequency of packet loss higher than the remaining items of the plurality of items. The server computer stores a plurality of snapshot data items, each of the plurality of snapshot data items comprising a frequency table, a snapshot time corresponding to the frequency table, an attribute of the monitored attribute type corresponding to the frequency table, and the identified one or more items for the frequency table.

### FIELD OF THE DISCLOSURE

The present disclosure is in the technical field of data communications over a network including network management processes and software and fault investigation. More specifically, the example embodiment(s) described below relate to tracking packet loss in communications between devices in packet-switched networks.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Networked communications are imperfect communication methods which involve sending large numbers of data packets over a network from one computing device to a receiving computing device. During communications, some data packets may fail to reach the destination computing device. The loss of data packets can be caused by a variety of issues, from network congestion to low bandwidth of a server computer to failing hardware devices.

Tracking packet loss over a network can be extremely tedious given the large number of packets sent over the network in each and every communication. Additionally, analyzing data regarding packet loss in communications can become computationally expensive given the vast amounts of data available.

Often, it is useful to identify sources of packet loss in communications. If a source can be detected, protocols can be implemented to fix the problem. For instance, if high packet loss is occurring due to a failing server rack, the identification of the server rack as the source of the packet loss would allow the server rack to be replaced. Unfortunately, storing enough packet loss data for each and every server rack on the off chance that one of them may exhibit higher than average packet loss is unfeasible.

It may also be useful to reduce packet loss for specific tenants or applications. For instance, a video conferencing application may be more adversely affected by packet loss than applications that do not run in real-time. Additionally, different tenants may have different requirements in communication stability based on individual needs.

Given the large number of data packets communicated through a network and the different parameters that are useful for tracking, it can be extremely difficult to monitor packet in a useful way that allows for identification of high packet loss with respect to a tenant, application, server rack, or other attributes without requiring an extremely large amount of storage or computationally expensive search algorithms.

Thus, there is a need for a system that can monitor communications over a network and generate data identifying packet loss over time for one or more attributes, such as server rack, application, or tenant, in a manner that reduces storage costs.

### BRIEF DESCRIPTION OF THE DRAWINGS

In the drawings:

FIG. 1 depicts a networked computer system, in an example embodiment.

FIG. 2 depicts an example method of generating frequency data relating to packet loss in communications for specific monitored attributes.

FIG. 3 depicts an example of snapshot data items being added to a snapshot database.

FIG. 4 is a block diagram that illustrates an example computer system with which an embodiment may be implemented.

### DETAILED DESCRIPTION

In the following description, for the purposes of explanation, numerous specific details are set forth in order to provide a thorough understanding of the present embodiments. It will be apparent, however, that the present embodiments may be practiced without these specific details. In other instances, well-known structures and devices are shown in block diagram form in order to avoid unnecessarily obscuring the present embodiments. Embodiments are described in sections below according to the following outline:

General Overview

Structural Overview

Drop-Rate Monitoring

Responsive Actions

Database Pruning

Benefits of Certain Embodiments

Implementation Example—Hardware Overview

General Overview

Techniques for monitoring packet loss in communications using stochastic algorithms are described herein. In an embodiment, a server computer receives communication data identifying packet loss events. The server computer generates frequency tables for each of a plurality of attributes of a monitored attribute type and updates the frequency tables using the communication data. For a snapshot time, the server computer generates a list of the items for each frequency table that have the highest frequency of packet loss. The server computer then generates a snapshot data item for each attribute with the frequency table of the attribute at the snapshot time, the list of items for the snapshot time and attribute, an identifier of the attribute, and an identifier of the snapshot time. The server computer stores the snapshot data item in a time series database which comprises snapshot data items for a plurality of snapshot times and a plurality of monitored attributes. A plurality of snapshot data items for a particular attribute and a plurality of different snapshot data items can be used to identify increases in packet loss for the attribute over time as well as highlighting the source of the items that have received steadily high packet loss over time.

In an embodiment, a method comprises receiving, from an electronic digital network element, data identifying a plurality of data packet drop events; creating and storing in computer memory a plurality of frequency tables which track packet loss for a plurality of items, each frequency table corresponding to an attribute of a monitored attribute type and a snapshot time; identifying, for each frequency table, one or more items of the plurality of items that are associated with a frequency of packet loss higher than the remaining items of the plurality of items; storing a plurality of snapshot data items, each of the plurality of snapshot data items comprising a frequency table, a snapshot time corresponding to the frequency table, an attribute of the monitored attribute type corresponding to the frequency table, and the identified one or more items for the frequency table.

In an embodiment, a system comprises one or more processors; a memory communicatively coupled to the one or more processors storing instructions which, when executed by the one or more processors, cause performance of: receiving, from an electronic digital network element, data identifying a plurality of data packet drop events; creating and storing in computer memory a plurality of frequency tables which track packet loss for a plurality of items, each frequency table corresponding to an attribute of a monitored attribute type and a snapshot time; identifying, for each frequency table, one or more items of the plurality of items that are associated with a frequency of packet loss higher than the remaining items of the plurality of items; and storing a plurality of snapshot data items, each of the plurality of snapshot data items comprising a frequency table, a snapshot time corresponding to the frequency table, an attribute of the monitored attribute type corresponding to the frequency table, and the identified one or more items for the frequency table.

Structural Overview

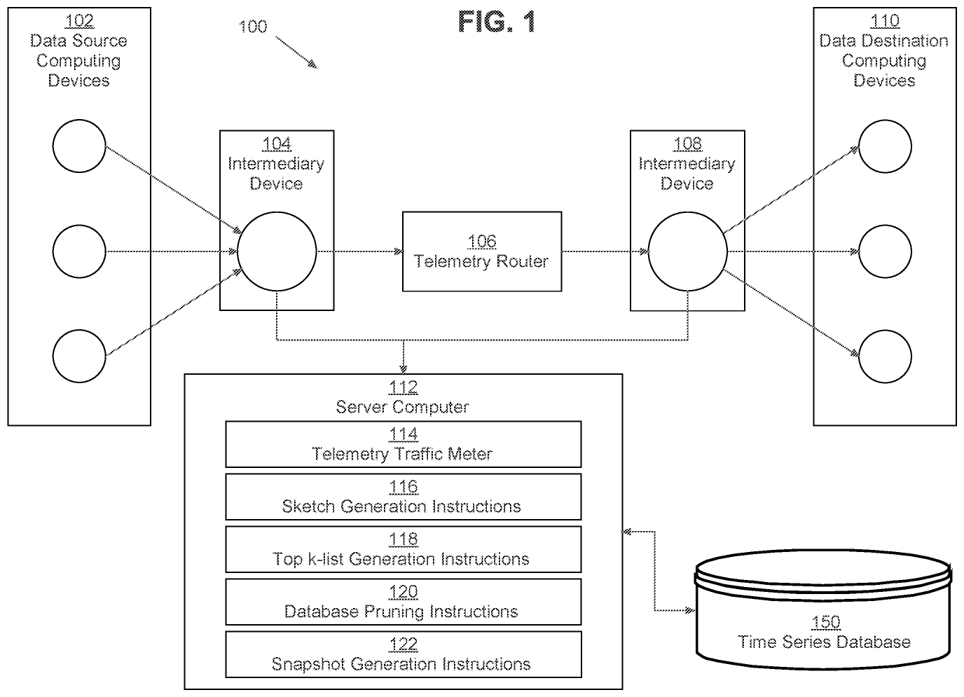

FIG. 1 depicts a networked computer system, in an example embodiment.

In an embodiment, the computer system 100 comprises components that are implemented at least partially by hardware at one or more computing devices, such as one or more hardware processors executing program instructions stored in one or more memories for performing the functions that are described herein. All functions described herein are intended to indicate operations that are performed using programming in a special-purpose computer or general-purpose computer, in various embodiments. A “computer” may be one or more physical computers, virtual computers, and/or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, computer network devices such as gateways, modems, routers, access points, switches, hubs, firewalls, and/or any other special-purpose computing devices. Any reference to “a computer” herein may mean one or more computers, unless expressly stated otherwise.

In the example of FIG. 1, a networked computer system 100 may facilitate the secure exchange of data between programmed computing devices. Therefore, each of elements 102, 104, 106, 108, 110, 112, and 150 of FIG. 1 may represent one or more computers that are configured to provide the functions and operations that are described further herein in connection with network communication. FIG. 1 depicts only one of many possible arrangements of components configured to execute the programming described herein. Other arrangements may include fewer or different components, and the division of work between the components may vary depending on the arrangement. For example, any number of switches, routers, or other network devices may be used to facilitate communication between any number of endpoint devices. In an embodiment, there may be a plurality of intermediary devices between the data source computing devices 102 and the telemetry router 106. Additionally or alternatively, either data source computing device 102 or telemetry router 106 may send data to server computer 112 for tracking of network traffic.

The various elements of FIG. 1 may send data over one or more networks. The one or more networks broadly represents a combination of one or more local area networks (LANs), wide area networks (WANs), metropolitan area networks (MANs), global interconnected internetworks, such as the public internet, or a combination thereof. Each such network may use or execute stored programs that implement internetworking protocols according to standards such as the Open Systems Interconnect (OSI) multi-layer networking model, including but not limited to Transmission Control Protocol (TCP) or User Datagram Protocol (UDP), Internet Protocol (IP), Hypertext Transfer Protocol (HTTP), and so forth.

In an embodiment, data source computing device 102 are configured to communicate with data destination computing device 110 over a network through telemetry router 106. Intermediary devices 104 and 108 are configured retrieve data related to communications between data source computing device 102 and data destination computing devices 110 and send the retrieved data to server computer 112. The data may include identifiers of the internet protocol (IP) addresses of the data source computing devices and data destination computing devices, ports of the data source computing devices and data destination computing devices, network protocol over which the communication is sent, and communication data, such as a number of packets of data sent from data source computing device 102 and a number of packets received at data destination computing devices 110.

Server computer 112 is programmed or configured to track packet loss in communications between data source computing devices 102 and data destination computing devices 110 as described further herein. Server computer 112 comprises telemetry traffic meter 114, sketch generation instructions 116, top k-list generation instructions 118, database pruning instructions 120, and snapshot generation instructions 122. The instructions identified above are executable instructions and may comprise one or more executable files or programs that have been compiled or otherwise built based upon source code prepared in JAVA, C++, OBJECTIVE-C or any other suitable programming environment.

Telemetry traffic meter 114 may comprise a set of instructions which, when executed by one or more processors, cause server computer 112 to receive communication data over a network and/or compute packet loss values for communications between data source computing devices 102 and data destination computing devices 110. Sketch generation instructions 116 may comprise a set of instructions which, when executed by one or more processors, cause server computer 112 to generate frequency tables describing the frequency of packet drops in communications between data source computing devices 102 and data destination computing devices 110. Top-k list generation instructions may comprise a set of instructions which, when executed by one or more processors, cause server computer 112 to identify communication data items which have the highest frequencies of packet loss based on stored frequency tables. Database pruning instructions 120 may comprise a set of instructions which, when executed by one or more processors, cause server computer 112 to identify stored snapshot data items in a time-series database for removal from the time-series database. Snapshot generation instructions 122 may comprise a set of instructions which, when executed by one or more processors, cause server computer 112 to generate and store snapshot data items comprising a frequency table corresponding to a snapshot time and a top-k list corresponding to the snapshot time.

Time series database 150 comprises a database for storing snapshot data items for a plurality of snapshot times. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

Drop-Rate Monitoring

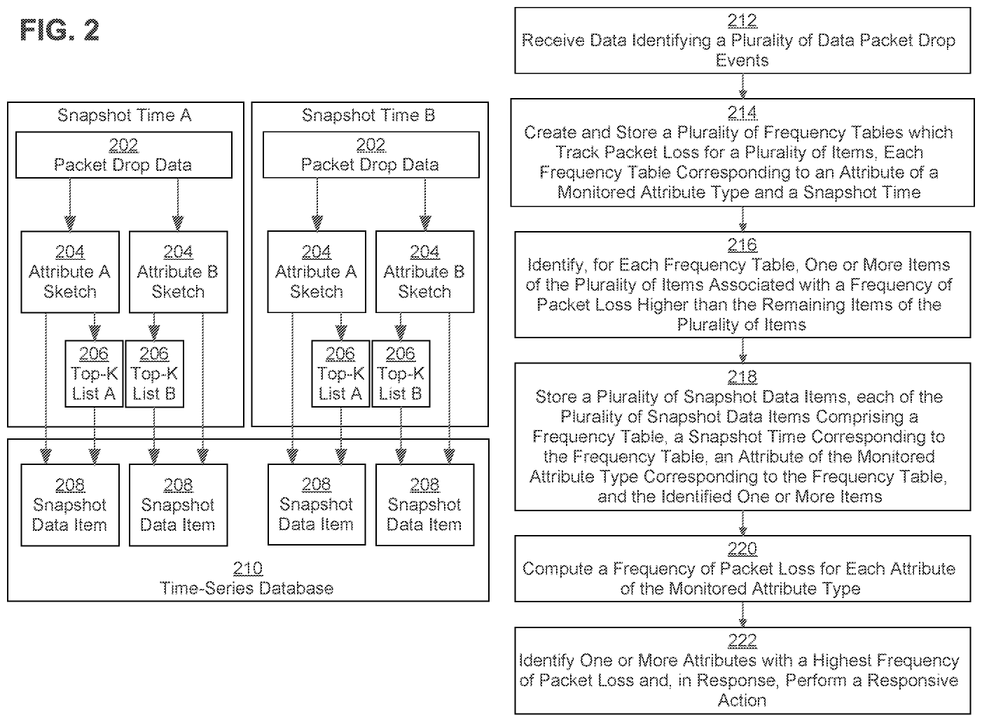

FIG. 2 depicts an example method of generating frequency data relating to packet loss in communications for specific monitored attributes. While the example of FIG. 2 relates to packet loss generally, embodiments may be performed with other distinct events, such as error codes, flags, or temperature monitoring. The methods described herein may provide an improvement in accuracy of monitoring packet loss in electronic digital packet-switched networks and internetworks such as local area networks (LANs), wide area networks (WANs), metropolitan area networks (MANs), global interconnected internetworks, such as the public internet, or a combination thereof.

At step 212, a computer receives data identifying a plurality of data packet drop events. For example, the server computer may receive data identifying packet loss from a telemetry meter which tracks packet loss in communications between data sources and data destinations. As another example, a server computer, such as server computer 112 may retrieve data from intermediary devices 104 and 108 which identify a number of packets in each communication. Based on the number of packets for a communication at intermediary device 104 and intermediary device 108, the computer may compute packet loss for the communication. Additionally or alternatively, a network interface may be employed which detects if a packet drop has occurred and sends data to the server computer indicating that a packet drop has occurred through one or more of a syslog message, an application programming interface (API), a software defined networking (SDN) controller, or an in-situ operation, administration, and maintenance (iOAM) mechanism.

At step 214, the computer creates and stores a plurality of frequency tables which track packet loss for a plurality of items. The plurality of items, as used herein, refer to specific communications. For example, a tracked item may comprise communications with the same source IP, source port, destination IP, destination port, and network protocol. The server computer may generate an identifier for each item, such as a tuple of the source IP, source port, destination IP, destination port, and network protocol.

The frequency table may be used to track frequency of packet drop events in communications for each item. For example, the server computer 112 may use packet drop data 202 to update sketches 204. In an embodiment, the frequency table is a count-min sketch data structure which uses the tracked item tuple as input into the hash functions of the count-min sketch, thereby incrementing the frequency counters for the item by one each time a packet drop event is identified for the item.

In an embodiment, a frequency table is maintained for each attribute of one or more monitored attributes. Monitored attributes may include tenants, physical location of a server rack in a data center, a geographic location, an identification of a virtual server, an application, a set of applications, an accessed database, or a type of hardware. For example, if the server computer is tracking packet drop events for four tenants, the server computer may maintain four frequency tables, one for each tenant. Additionally or alternatively, the server computer may maintain frequency tables for combinations of monitored attributes. For example, the server computer may maintain frequency tables for each combination of tenant and location. Thus, if there are three tenants with four locations, the server computer may maintain twelve frequency tables, one for each combination of tenant and location.

Attributes may be monitored at different levels of granularity using different sketches. For example, a first sketch may track the frequency of packet drop events at different datacenters while a plurality of second sketches track the frequency of packet drop events at different server racks in each datacenter. As another example, the server computer may store a sketch that tracks packet drop events for each of a plurality of groups of tenants. The server computer may also store a sketch for each group of tenants that tracks packed drop events for each tenant of the group of tenants.

In FIG. 2, a sketch 204 is stored for two different attributes, attribute A and attribute B. As an example, attribute A may be a first tenant and attribute B may be a second tenant. The sketches 204 are stored for each attribute at a plurality of snapshot times. A snapshot time, as used herein, refers to a time up until which data from packet drop data is used. For instance, if a snapshot time is 17:43:00, then packet drop events that occurred prior to 17:43:00 may be included in the sketch for the snapshot time, but packet drop events that occurred after 17:43:00 may not be included in the sketch for the snapshot time. The server computer may generate snapshot data items 208 at particular intervals, such as every ten seconds and/or at specific times during the day. Each snapshot data item is generated from a sketch that is current up until the snapshot time for the snapshot data item.

At step 216, the computer identifies, for each frequency table, one or more items of the plurality of items associated with a frequency of packet loss higher than the remaining items of the plurality of items. For example, the server computer may generate top-k lists 206 from sketches 204. Top-k lists 206 comprise lists of items from the sketch with the highest frequency of packet drop events. The k may be a preset value and/or a configurable value which identifies a number of items on the top-k list. For example, a top-5 list may include the five items in the sketch with the highest frequency of packet drop events. The server computer may query the frequency table using one or more hash functions to identify the top-k items at the snapshot time.

At step 218, the computer stores a plurality of snapshot data items. Each snapshot data item may comprise a frequency table, a snapshot time corresponding to the frequency table, an attribute of the monitored attribute type corresponding to the frequency table, and the identified one or more items. For example, the server computer may generate snapshot data items 208 from attribute sketches 204 and top-k lists 206. Each snapshot data item corresponds to one or more attributes of a monitored attribute type and a snapshot time, thereby allowing for temporal monitoring of specific attribute as described further herein.

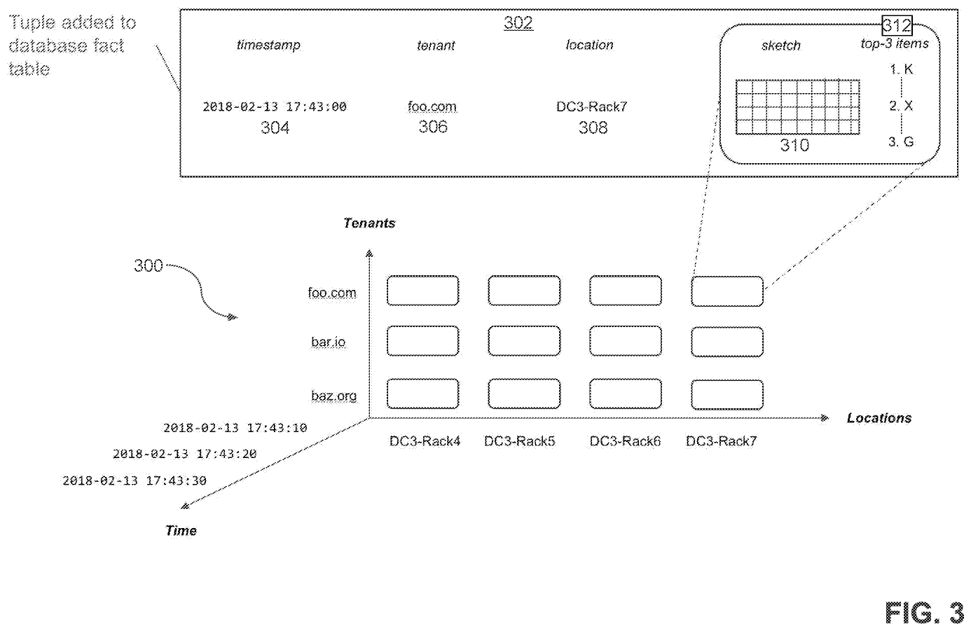

FIG. 3 depicts an example of snapshot data items being added to a snapshot database. In FIG. 3, a snapshot data item 302 is added to a snapshot database. The snapshot data item comprises a timestamp 304, tenant identifier 306, location 308, sketch 310, and top-3 item list 312. As shown in graph 300, each sketch 310 and top-3 item list corresponds to a location, tenant, and timestamp. In an embodiment, the server computer generates the snapshot data item 302 as a tuple of the timestamp, tenant identifier, location, sketch, and top-3 item list.

Referring again to FIG. 2, at step 220, the server computer computes a frequency of packet loss for each attribute of the monitored attribute type. The frequency of packet loss may correspond to changes in packet loss for individual data items. For example, using the top-k list for each, the server computer may compute a change in the frequency of packet loss for items in the top-k list over time. By storing frequency tables and top-k lists for specific attributes over time, the server computer is able to compute changes in the frequency of packet loss over time for individual items and/or for the attribute generally, thereby allowing for a responsive action to be taken.

At step 222, one or more attributes with a highest frequency of packet loss is identified and, in response, a responsive action is performed. While FIG. 2 describes responsive actions being performed in response to an identification of a highest frequency of packet loss, the server computer may generally perform responsive actions based on other factors, such as packet loss for an attribute being over a threshold value. Methods of performing responsive actions based on the snapshot data items are described further herein.

Responsive Actions

In an embodiment, the server computer uses the snapshot data items to determine a server rack for replacement. For example, the server computer may track packet loss for a plurality of locations using a frequency table for each location. The server computer may identify locations with an increasing frequency of packet loss over time using a plurality of snapshot data items for the location. The server computer may identify locations with the highest average packet loss over a plurality of snapshot data items, locations with the highest packet loss at a particular snapshot and a historically rising frequency of packet loss, and/or locations with packet loss values above a stored threshold value and a historically rising frequency of packet loss. The server computer may send data to a client computing device identifying the high frequency locations so that a server rack may be located. By using a plurality of snapshots with individual frequency tables, the server computer is able to identify server racks with increasing packet loss over time instead of server racks with an instantaneous high packet loss which could be caused by other factors.

In an embodiment, the server computer uses the snapshot data items to dynamically adjust container or cloud environment usage based on drop rates over time. For example, the server computer may store a threshold value for a particular tenant identifying a minimum level of quality for communications. The server computer may use the stored snapshot data items for the particular tenant to identify a frequency of packet drops. If the frequency of packet drops for the tenant begins to decrease below the threshold value, the server computer may adjust the server usage for the particular tenant to decrease packet loss. For example, communications for the tenant may be moved to a server with higher bandwidth. Additionally or alternatively, the server computer may identify particular items for the tenant which are causing the high frequency of packet loss from the top-k list and redistribute the items to different server computers.

While the above example describes threshold values for a particular tenant, the methods described herein may be used to optimize communications for a plurality of tenants. For example, the server computer may store a threshold value for a plurality of tenants and redistribute communication items for any of the plurality of tenants which have packet loss below the threshold value. Additionally or alternatively, the server computer may store different threshold values for different groups. Thus, a first group may have a lower threshold value than a second group. The server computer may thus utilize the frequency data to identify locations with higher packet drop rates and redistribute communications such that communications corresponding to tenants with the lower threshold value are assigned to the locations with the higher packet drop rates and communications corresponding to tenants with the higher threshold value are not assigned to the locations with the higher packet drop rates.

In an embodiment, the server computer uses the snapshot data items to identify oversubscription or over-utilization of specific resources. For example, the server computer may generate snapshot data items for different hardware resources within a larger set, such as a server rack in a datacenter or a specific endpoint type within an overall cloud. The server computer may reference the top-k lists in the snapshot data items to identify risks and provide an early warning system for hardware resources which frequently appear on the top-k list.

The server computer may review items on the top-k list to identify items with abnormally high frequencies of packet drop events. The server computer may monitor data usage of the hardware resources with which the identified items are associated to determine if the hardware resource requires updates, utilization shifts, and/or other improvements. In an embodiment, the server computer sends the monitoring data to a client computing device indicating which resources are at risk. Additionally or alternatively, the server computer may automatically update monitored resources and/or decrease usage of the monitored resources.

In an embodiment, the server computer uses the snapshot data items to optimize service chains. A service chain, as used herein, refers to a specific data flow with a series of preset services and/or endpoints. While a service chain includes predetermined flows of information, the server computer may adjust the flow to increase the performance of the computers based on the snapshot data items. For example, the server computer may use the top-k lists to identify endpoints with high rates of packet loss. While the endpoint may not be avoidable for a service flow, the server computer may dynamically decrease or increase the size of packets around the identified endpoints to ensure higher quality data flows.

In an embodiment, the server computer uses the snapshot data items to identify applications, impacted services, and/or tenants for which loss mitigation techniques are to be performed. For example, the server computer may use the top-k lists to identify applications, services, and/or tenants that are suffering from data loss. The server computer may apply packet loss mitigation techniques, such as multimedia session rerouting or configuration updates, to the applications, services, and/or tenants to provide a more predictable performance profile and a better user experience.

Database Pruning

Storing snapshot data items comprising sketches for different attributes, combinations of attributes, and snapshot times can utilize a large amount of storage space. Storage usage is increased when an interval between snapshot times is short, such as ten seconds, or when a large number of attributes are monitored alone and/or in combination. The server computer may reduce storage costs by pruning the time-series database of snapshot data items. In an embodiment, to ensure accuracy and usefulness of the time-series database, the server computer may prune the database based on frequency of use of a data item and length of time that the item has been stored. Methods of database pruning based on frequency of data item usage and age of item are described further herein.

In an embodiment, the server computer uses the Window TinyLFU algorithm for determining when to remove snapshot data items. The server computer initially stores snapshot data items in a probation queue. The snapshot data items are stored in the probation queue for a specific period of time based on the Window TinyLFU algorithm and/or until a snapshot data item is to be added to the probation queue after the probation queue is full. The server computer additionally stores data indicating usage of stored snapshot data items.

When the snapshot data item is removed from the probation queue, the server computer determines whether to promote the snapshot data item to a protective queue or to remove the snapshot data item from storage. To determine whether to promote the snapshot data item to the protective queue, the server computer determines if the frequency of usage of the snapshot data item over a prior period of time was higher than the frequency of usage of the least used snapshot data item in the protective queue, i.e. the snapshot data item in the protective queue with the lowest frequency of usage over the period of time.

If the frequency of usage of the snapshot data item is higher than the frequency of usage of the snapshot data item stored in the probation queue is not higher than the frequency of usage of the least used snapshot data item stored in the protective queue, the server computer may remove the snapshot data item from storage. If the frequency of usage of the snapshot data item is higher than the that of the least used snapshot data item in the protective queue, the server computer may store the snapshot data item in the protective queue and eject the least used snapshot data item from the protective queue if the protective queue is full. The ejected snapshot data item may be placed back into the probationary queue.

By using the methods described herein the prune the time-series database, snapshot data items are given time to be queried before a decision is made as to whether they should be stored or deleted. This allows snapshot data items that are not obviously initially important to be kept around in case they are required for analytics. Additionally, protected items that have not been accessed recently are placed back into the probation queue, thereby allowing items which have not seen recent use to still be queried in case the lack of recent need for the item was an anomaly.

Benefits of Certain Embodiments

The systems and methods described herein provide a means for identifying failures in online communications. By using frequency tables, the server computer is able to track the frequencies of packet loss events across different attributes in a manner that reduces storage costs and analyzing difficulties. By storing snapshot data items for a plurality of snapshot times, the server computer can easily identify increasing frequencies of packet loss by communication item and/or attribute of communication, thereby allowing the server computer to identify and correct causes of communication failures.

Additionally, the systems and methods described herein allow a server computer to reduce storage costs of tracking packet loss over time for a plurality of attributes of a monitored attribute type while maintaining the usefulness of the stored data. Specifically, the pruning methods described herein allow the server computer to determine whether snapshot data items are likely to be useful prior to removing them from the database, thereby providing a balance between the benefits of reducing storage costs and the risks inherent in removing snapshot data items which are not immediately useful but may be come useful as more data is received.

Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

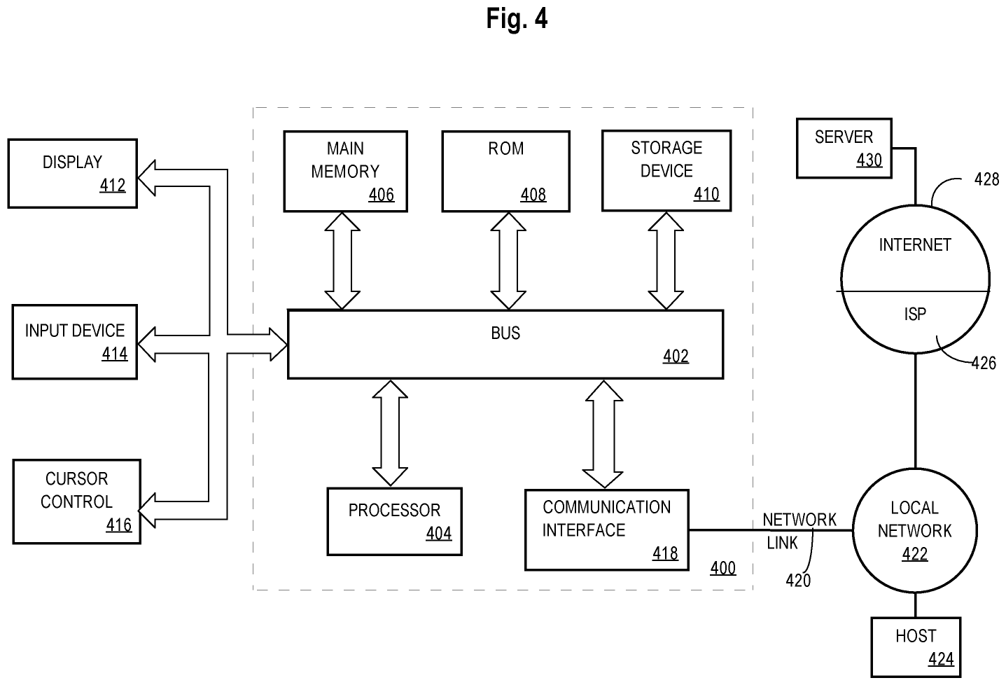

FIG. 4 is a block diagram that illustrates an example computer system with which an embodiment may be implemented. In the example of FIG. 4, a computer system 400 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 400 includes an input/output (I/O) subsystem 402 which may include a bus and/or other communication mechanism(s) for communicating information and/or instructions between the components of the computer system 400 over electronic signal paths. The I/O subsystem 402 may include an I/O controller, a memory controller and at least one I/O port. The electronic signal paths are represented schematically in the drawings, for example as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system or a graphics processing unit (GPU) or a digital signal processor or ARM processor. Processor 404 may comprise an integrated arithmetic logic unit (ALU) or may be coupled to a separate ALU.

Computer system 400 includes one or more units of memory 406, such as a main memory, which is coupled to I/O subsystem 402 for electronically digitally storing data and instructions to be executed by processor 404. Memory 406 may include volatile memory such as various forms of random-access memory (RAM) or other dynamic storage device. Memory 406 also may be used for storing temporary variables or other intermediate information during execution of instructions to be executed by processor 404. Such instructions, when stored in non-transitory computer-readable storage media accessible to processor 404, can render computer system 400 into a special-purpose machine that is customized to perform the operations specified in the instructions.

Computer system 400 further includes non-volatile memory such as read only memory (ROM) 408 or other static storage device coupled to I/O subsystem 402 for storing information and instructions for processor 404. The ROM 408 may include various forms of programmable ROM (PROM) such as erasable PROM (EPROM) or electrically erasable PROM (EEPROM). A unit of persistent storage 410 may include various forms of non-volatile RAM (NVRAM), such as FLASH memory, or solid-state storage, magnetic disk or optical disk such as CD-ROM or DVD-ROM, and may be coupled to I/O subsystem 402 for storing information and instructions. Storage 410 is an example of a non-transitory computer-readable medium that may be used to store instructions and data which when executed by the processor 404 cause performing computer-implemented methods to execute the techniques herein.

The instructions in memory 406, ROM 408 or storage 410 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 400 may be coupled via I/O subsystem 402 to at least one output device 412. In one embodiment, output device 412 is a digital computer display. Examples of a display that may be used in various embodiments include a touch screen display or a light-emitting diode (LED) display or a liquid crystal display (LCD) or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators or servos.

At least one input device 414 is coupled to I/O subsystem 402 for communicating signals, data, command selections or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical interface on a display screen, alternatively or in addition to input functions. Control device 416 may be a touchpad, a mouse, a trackball, or cursor direction keys for communicating direction information and command selections to processor 404 and for controlling cursor movement on output device (e.g., display) 412. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 414 may include a combination of multiple different input devices, such as a video camera and a depth sensor.

In another embodiment, computer system 400 may comprise an internet of things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware and interfaces for generating position reporting packets, notifications, pulse or heartbeat signals, or other recurring data transmissions that specify a position of the computer system 400, alone or in combination with other application-specific data, directed toward host 424 or server 430.

Computer system 400 may implement the techniques described herein using customized hard-wired logic, at least one ASIC, GPU, or FPGA, firmware and/or program instructions or logic which when loaded and used or executed in combination with the computer system causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 402. Transmission media can also take the form of acoustic or light waves, such as those generated during radio-wave and infra-red data communications.

Various forms of media may be involved in carrying at least one sequence of at least one instruction to processor 404 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 400 can receive the data on the communication link and convert the data to a format that can be read by computer system 400. For instance, a receiver such as a radio frequency antenna or an infrared detector can receive the data carried in a wireless or optical signal and appropriate circuitry can provide the data to I/O subsystem 402 such as place the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to bus 402. Communication interface 418 provides a two-way data communication coupling to network link(s) 420 that are directly or indirectly connected to at least one communication networks, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 422 broadly represents a local area network (LAN), wide-area network (WAN), campus network, internetwork or any combination thereof. Communication interface 418 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may provide a connection through a network 422 to a host computer 424.

Furthermore, network link 420 may provide a connection through network 422 or to other computing devices via internetworking devices and/or computers that are operated by an Internet Service Provider (ISP) 426. ISP 426 provides data communication services through a world-wide packet data communication network represented as internet 428. A server computer 430 may be coupled to internet 428. Server 430 broadly represents any computer, data center, virtual machine or virtual computing instance with or without a hypervisor, or computer executing a containerized program system such as DOCKER or KUBERNETES. Server 430 may represent an electronic digital service that is implemented using more than one computer or instance and that is accessed and used by transmitting web services requests, uniform resource locator (URL) strings with parameters in HTTP payloads, API calls, app services calls, or other service calls. Computer system 400 and server 430 may form elements of a distributed computing system that includes other computers, a processing cluster, server farm or other organization of computers that cooperate to perform tasks or execute applications or services. Server 430 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 430 may comprise a web application server that hosts a presentation layer, application layer and data storage layer such as a relational database system using structured query language (SQL) or no SQL, an object store, a graph database, a flat file system or other data storage.

Computer system 400 can send messages and receive data and instructions, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage 410, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

What is claimed is:

1. A method providing an improvement in accuracy of monitoring packet loss in electronic digital packet-switched networks and internetworks, the method comprising:
receiving, from an electronic digital network element, data identifying a plurality of data packet drop events;
creating and storing in computer memory a plurality of frequency tables which track packet loss for a plurality of items, each frequency table corresponding to an attribute of a monitored attribute type and a snapshot time;
identifying, for each frequency table, one or more items of the plurality of items that are associated with a frequency of packet loss higher than the remaining items of the plurality of items; and
storing a plurality of snapshot data items, each of the plurality of snapshot data items comprising a frequency table, a snapshot time corresponding to the frequency table, an attribute of the monitored attribute type corresponding to the frequency table, and the identified one or more items for the frequency table.

2. The method of claim 1, wherein the monitored attribute type is one or more of a tenant, a physical location of a server rack in a data center, a geographic location, an application, a set of applications, an accessed database, or a type of hardware.

3. The method of claim 1, further comprising:
using the plurality of snapshot data items, computing a frequency of packet loss for each attribute of the monitored attribute type; and
identifying one or more attributes with a highest frequency of packet loss and, in response, performing a responsive action with respect to the identified one or more attributes.

4. The method of claim 3, wherein the responsive action comprises:
identifying one or more resources with the identified one or more attributes; and
altering the identified one or more resources to no longer have the identified one or more attributes.

5. The method of claim 3, wherein the responsive action comprises sending a warning to a client computing device identifying the one or more attributes with the highest frequency of packet loss.

6. The method of claim 3, wherein the responsive action comprises optimizing a flow in a service chain which uses the one or more attributes with the highest frequency of packet loss.

7. The method of claim 3, wherein the responsive action comprises applying one or more packet loss mitigation techniques to data streams with the identified one or more attributes.

8. The method of claim 3, wherein the responsive action comprises:
identifying one or more resources with the identified one or more attributes; and
dynamically increasing or decreasing a size of packets sent to the identified one or more resources.

9. The method of claim 1, further comprising:
storing the plurality of snapshot data items in a probation queue;
removing a particular snapshot data item from the probation queue;
determining whether a frequency of use of the particular snapshot data item is greater than a frequency of use of a least used snapshot data item in a protective queue;
if the frequency of use of the particular snapshot data item is less than or equal to the frequency of use of the least used snapshot data item in the protective queue, removing the particular snapshot data item; and
if the frequency of use of the particular snapshot data item is greater than the frequency of use of the least used snapshot data item in the protective queue, storing the particular snapshot data item in the protective queue.

10. The method of claim 1, wherein each item of the plurality of items comprises a 5-tuple of a communication's source internet protocol (IP) address, source port, destination IP address, destination port, and network protocol.

11. A system comprising:
one or more processors;
a memory communicatively coupled to the one or more processors storing instructions which, when executed by the one or more processors, cause performance of:
receiving, from an electronic digital network element, data identifying a plurality of data packet drop events;
creating and storing in computer memory a plurality of frequency tables which track packet loss for a plurality of items, each frequency table corresponding to an attribute of a monitored attribute type and a snapshot time;
identifying, for each frequency table, one or more items of the plurality of items that are associated with a frequency of packet loss higher than the remaining items of the plurality of items; and
storing a plurality of snapshot data items, each of the plurality of snapshot data items comprising a frequency table, a snapshot time corresponding to the frequency table, an attribute of the monitored attribute type corresponding to the frequency table, and the identified one or more items for the frequency table.

12. The system of claim 11, wherein the monitored attribute type is one or more of a tenant, a physical location of a server rack in a data center, a geographic location, an application, a set of applications, an accessed database, or a type of hardware.

13. The system of claim 11, wherein the instructions, when executed by the one or more processors, further cause performance of:
using the plurality of snapshot data items, computing a frequency of packet loss for each attribute of the monitored attribute type; and
identifying one or more attributes with a highest frequency of packet loss and, in response, performing a responsive action with respect to the identified one or more attributes.

14. The system of claim 13, wherein the responsive action comprises:
identifying one or more resources with the identified one or more attributes; and
altering the identified one or more resources to no longer have the identified one or more attributes.

15. The system of claim 13, wherein the responsive action comprises sending a warning to a client computing device identifying the one or more attributes with the highest frequency of packet loss.

16. The system of claim 13, wherein the responsive action comprises optimizing a flow in a service chain which uses the one or more attributes with the highest frequency of packet loss.

17. The system of claim 13, wherein the responsive action comprises applying one or more packet loss mitigation techniques to data streams with the identified one or more attributes.

18. The system of claim 13, wherein the responsive action comprises:
identifying one or more resources with the identified one or more attributes; and
dynamically increasing or decreasing a size of packets sent to the identified one or more resources.

19. The system of claim 11, wherein the instructions, when executed by the one or more processors, further cause performance of:
storing the plurality of snapshot data items in a probation queue;
removing a particular snapshot data item from the probation queue;
determining whether a frequency of use of the particular snapshot data item is greater than a frequency of use of a least used snapshot data item in a protective queue;
if the frequency of use of the particular snapshot data item is less than or equal to the frequency of use of the least used snapshot data item in the protective queue, removing the particular snapshot data item; and
if the frequency of use of the particular snapshot data item is greater than the frequency of use of the least used snapshot data item in the protective queue, storing the particular snapshot data item in the protective queue.

20. The system of claim 10, wherein each item of the plurality of items comprises a 5-tuple of a communication's source internet protocol (IP) address, source port, destination IP address, destination port, and network protocol.
